(19) United States
(12) Patent Application Publication
(10) Pub. No.: US 2008/0192854 A1
(43) Pub. Date: Aug. 14, 2008

(54) SINGLE CARRIER FREQUENCY DIVISION MULTIPLE ACCESS RECEIVER FOR MIMO SYSTEMS

(76) Inventors: Taeyoon Kim, Austin, TX (US); James W. McCoy, Austin, TX (US); Oghenekome F. Oteri, Austin, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/673,163

(22) Filed: Feb. 9, 2007

(51) Int. Cl. H04B 7/02

(52) U.S. Cl. 375/267

(57) ABSTRACT

A method for processing symbols transmitted via a first plurality of antennas and received via a second plurality of antennas is provided. The method includes receiving symbol streams corresponding to a sub-carrier frequency from each of the second plurality of antennas. The method further includes generating estimated symbol streams for the sub-carrier frequency for each of the first plurality of antennas. The method further includes selecting an estimated symbol stream corresponding to one of the first plurality of antennas for interference cancellation. The method further includes transforming the selected symbol stream into time domain and decoding the selected symbol stream. The method further includes transforming the decoded symbol stream into frequency domain. The method further includes performing interference cancellation using the decoded symbol stream.

### BACKGROUND

1. Field

This disclosure relates generally to communication methods and systems, and more particularly to a receiver for single-carrier frequency division multiple access (SC-FDMA) systems.

2. Related Art

Multi-antenna systems, such as MIMO systems can be used to improve data rate and error performance in single-carrier frequency division multiple access (SC-FDMA) systems. Conventionally, in such systems, at the receiver, decoding of the modulated symbols (symbol decoding) and MIMO operation have been both performed either in frequency domain or in time domain. When both of these operations are performed in the frequency domain, then while MIMO operation has a lower complexity the symbol decoding operation has a higher complexity. In contrast, when both of these operations are performed in time domain, then while symbol decoding operation has a lower complexity, the MIMO operation has a higher complexity. To address this problem, there is a need for better systems and methods for processing symbols at the receiver end in SC-FDMA systems.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is an exemplary block diagram of a receiver;

FIG. 2 is an exemplary block diagram of a portion of the receiver of FIG. 1; and

FIG. 3 is an exemplary system environment for the receiver of FIGS. 1 and 2.

### DETAILED DESCRIPTION

In one aspect, a method for processing symbols transmitted via a first plurality of antennas and received via a second plurality of antennas is provided. The method includes receiving symbol streams corresponding to a sub-carrier frequency from each of the second plurality of antennas. The method further includes generating estimated symbol streams for the sub-carrier frequency for each of the first plurality of antennas. The method further includes selecting an estimated symbol stream corresponding to one of the first plurality of antennas for interference cancellation. The method further includes transforming the selected symbol stream into time domain and decoding the selected symbol stream. The method further includes transforming the decoded symbol stream into frequency domain. The method further includes performing interference cancellation using the decoded symbol stream.

In another aspect, a receiver for processing symbols transmitted via a first plurality of antennas is provided. The receiver includes a second plurality of antennas for receiving symbol streams corresponding to a sub-carrier frequency. The receiver further includes at least one block for generating estimated symbol streams for the sub-carrier frequency for each of the first plurality of antennas. The receiver further includes at least one block for selecting an estimated symbol stream corresponding to one of the first plurality of antennas for interference cancellation. The receiver further includes at least one block for transforming the selected symbol stream into time domain and decoding the selected symbol stream. The receiver further includes at least one block for transforming the decoded symbol stream into frequency domain. The receiver further includes at least one block for performing interference cancellation using the decoded symbol stream.

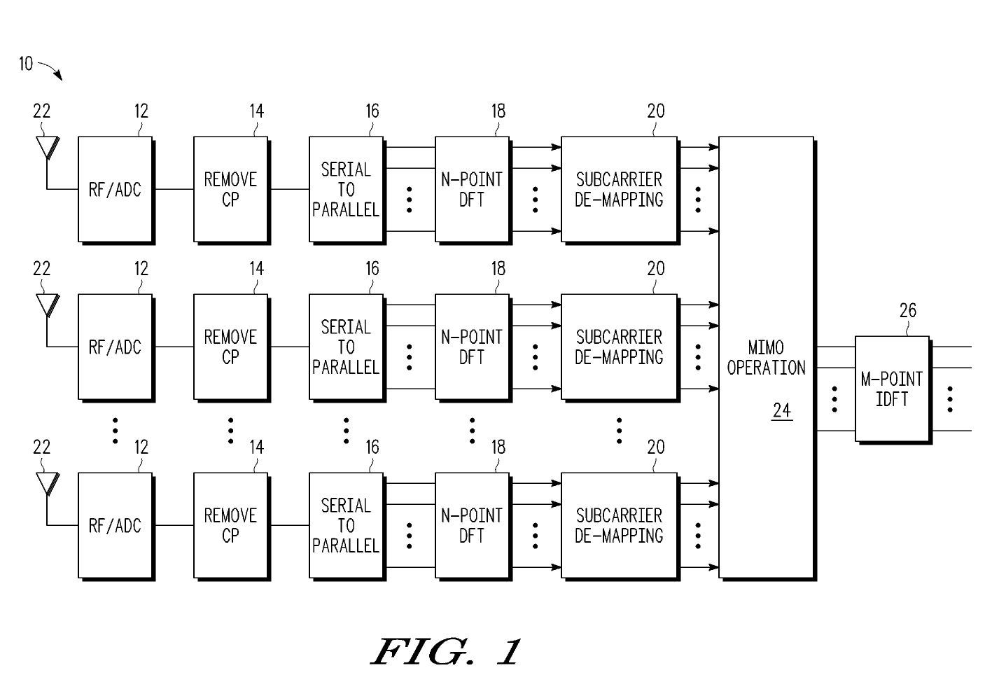

FIG. 1 is an exemplary block diagram of a receiver 10. Exemplary receiver 10 may be a single carrier frequency division multiple access (SC-FDMA) receiver. Thus, for example, a mobile device may use a SC-FDMA signal, which typically has a lower peak-to-average power ratio (PAPR) to transmit signals on the up-link channel to a base station, for example. In such an instance, receiver 10 may be implemented as part of a base station. Receiver 10 may include several antennas 22 for receiving signals. Each antenna 22 may be coupled to a RF/ADC block 12, a REMOVE CP block 14, a SERIAL TO PARALLEL block 16, a N-POINT DFT block 18, and a SUBCARRIER DE-MAPPING/EQUALIZATION block 20. The output of SUBCARRIER DE-MAPPING/EQUALIZATION block 20 may be coupled to a MIMO OPERATION block 24, which may further be coupled to a M-POINT IDFT block 26, where M is the number of subcarriers per user. Although FIG. 1 shows a specific number of blocks arranged in a specific manner, additional or fewer blocks arranged differently may also be used. RF/ADC block 12 may perform radio frequency operations on the incoming signal, including the processing of the signals received via antenna 22. RF/ADC block 12 may also convert the received analog signals into digital signals. REMOVE CP block 14 may remove the cyclic prefix. SERIAL TO PARALLEL block 16 may convert the serial data into parallel data. N-POINT DFT block 18 may perform a discrete Fourier transform on the parallel data streams, where N is the number of subcarriers in the system. SUBCARRIER DE-MAPPING/EQUALIZATION block 20 may perform subcarrier de-mapping and equalization.

By way of example, the output of SUBCARRIER DE-MAPPING block 20 \tilde{d} may be represented, as follows:

$$\begin{matrix}\tilde{d} = {H}_{ft} s + w \\ = [ \begin{matrix}{Λ}_{M}^{( 1 , 1 )} F & {Λ}_{M}^{( 1 , 2 )} F & ⋯ & {Λ}_{M}^{( 1 , {M}_{t} )} F \\ {Λ}_{M}^{( 2 , 1 )} F & & ⋯ & {Λ}_{M}^{( 2 , {M}_{t} )} F \\ ⋮ & & ⋯ & ⋮ \\ {Λ}_{M}^{( {M}_{r} , 1 )} F & {Λ}_{M}^{( {M}_{r} , 2 )} F & ⋯ & {Λ}_{M}^{( {M}_{r} , {M}_{t} )} F\end{matrix} ] [ \begin{matrix}{s}^{( 1 )} \\ {s}^{( 2 )} \\ ⋮ \\ {s}^{( {M}_{t} )}\end{matrix} ] + w\end{matrix} \qquad \begin{matrix}Equation 1 \\ \\ Equation 2\end{matrix}$$

where, Λ_{M}^{(i,j)} is the matrix corresponding to the frequency channel response between the i^{th} transmit antenna and the j^{th} receive antenna over M subcarriers, F is the DFT matrix, M is the number of subcarriers per user, Mᵣ is the number of receive antennas, Mₜ is the number of transmit antennas, s⁽ⁱ⁾ is the vector of the transmit symbol at the i^{th} antenna, and w is the additive white Gaussian noise (AWGN) vector.

The de-mapped symbol streams may then be processed using MIMO OPERATION block 24. The output of MIMO OPERATION block 24 may be subjected to an inverse discrete Fourier transform operation by M-POINT IDFT block 26.

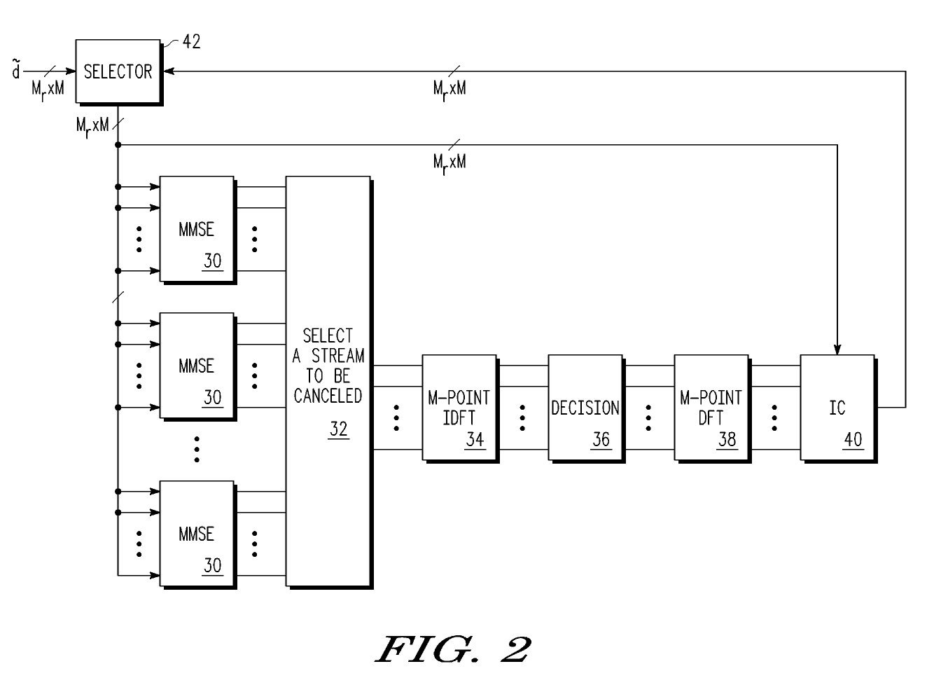

FIG. 2 is an exemplary block diagram for a portion of an exemplary receiver 10. After sub-carrier depmapping, the received Mᵣ×M symbol streams are processed using MIMO OPERATION block 24. As noted above, Mᵣ is the number of receive antennas and M is the number of subcarriers per user. As part of the processing by MIMO OPERATION block 24, estimated symbol streams for each sub-carrier frequency for each transmit antenna are generated. By way of example, estimated symbol streams may be generated using a minimum mean squared error (MMSE) algorithm. Thus, for example, each MMSE block 30 can be used to process symbols corresponding to a particular sub-carrier frequency. Since there are M sub-carrier frequencies, FIG. 2 shows M MMSE blocks. Although FIG. 2 shows the generation of estimated symbol streams using MMSE, estimated symbol streams may be generated using other algorithms, such as zero-forcing, maximum likelihood (ML). By way of example, the MMSE operation may be performed using the following equation:

H_{ft}^{H}(H_{ft}H_{ft}^{H}+σ_{w}²I)⁻¹=D^{H}H_{ff}^{H}(H_{ft}H_{ff}^{H}+σ_{w}²I)⁻¹ Equation 3

where, D=I_{Mt}_{_{X}}_{^{M}}_{ₜ}\textcircled{x}F, and where as noted above with respect to Equation 2, F is the DFT matrix, I is the identify matrix, \textcircled{x} is the Kroneker product, H_{ft}^{H} is the conjugate transpose matrix H_{ft} as referred to above in Equations 1 and 2, σ_{w}² is the noise variance, and where H_{ff}

$${H}_{ff} = [ \begin{matrix}{Λ}_{M}^{( 1 , 1 )} & {Λ}_{M}^{( 1 , 2 )} & ⋯ & {Λ}_{M}^{( 1 , {M}_{t} )} \\ {Λ}_{M}^{( 2 , 1 )} & & ⋯ & {Λ}_{M}^{( 2 , {M}_{t} )} \\ ⋮ & & ⋯ & ⋮ \\ {Λ}_{M}^{( {M}_{r} , 1 )} & {Λ}_{M}^{( {M}_{r} , 2 )} & ⋯ & {Λ}_{M}^{( {M}_{r} , {M}_{t} )}\end{matrix} ]$$

Referring still to FIG. 2, once the estimated symbol streams are generated one of the estimated symbol streams may be selected for interference cancellation using block 32. The selected symbol stream will have symbols corresponding to M sub-carrier frequencies and one transmit antenna out of the Mₜ number of transmit antennas. As part of this process, the estimated symbol stream with the highest signal to interference and noise ratio (SINR) may be selected. Alternatively, the number of hybrid ARQ (HARQ) transmissions may be used to make the selection.

Next, using M-POINT IFDT block 34 the selected symbol stream may be converted from the frequency domain into time domain. Next, using DECISION 36 block, the selected symbol stream may be decoded. Next, using M-POINT DFT block 38 the decoded symbol stream may be converted back into frequency domain. Next, using IC block 40, interference cancellation may be performed. As part of this step, each one of the decoded symbol streams may be subtracted from the received symbol stream iteratively or successively. To accomplish this process, selector 42 may provide the received symbol streams \tilde{d} to the MMSE blocks for the first iteration. However, selector 42 may provide the output of IC block 40 for subsequent iterations.

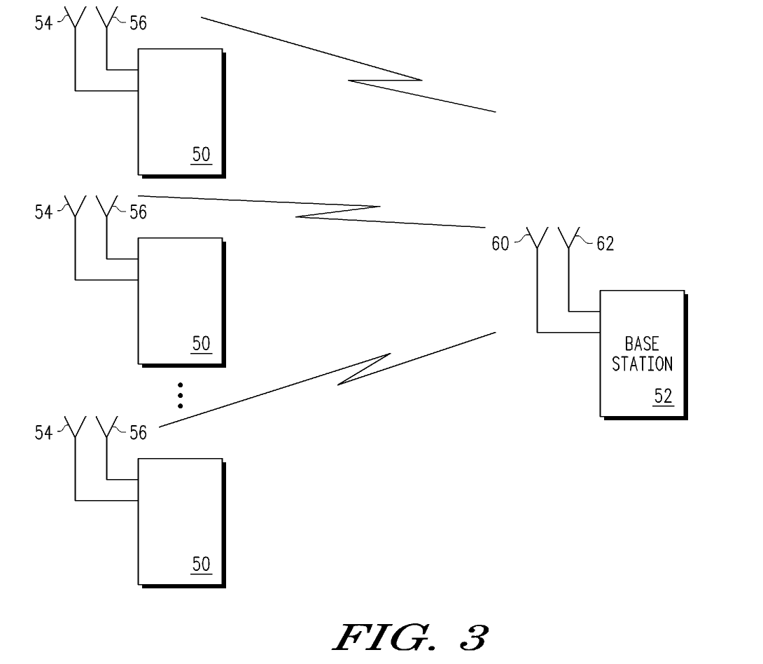

FIG. 3 is an exemplary system diagram for the exemplary receiver of FIGS. 1 and 2. By way of example, receiver 10 may be provided as part of base station 52, which may receive SC-FDMA signals via antennas 60 and 62 from various mobile devices 50 having antennas 54 and 56. Thus, transmit antennas Mₜ may correspond to antennas 54 and 56 and the number of receive antennas Mᵣ may correspond to antennas 60 and 62. Although FIG. 3 shows receiver 10 as part of a base station 52, receiver 10 may be used as part of any device that needs to receive SC-FDMA signals. By way of example, receiver 10 may be implemented in 3GPP Long Term Evolution (LTE) and/or Evolved UTRA compliant devices.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the invention is described herein with reference to specific embodiments, various modifications and changes can be made without departing from the scope of the present invention as set forth in the claims below. For example, the methods described herein may be implemented by various means. For example, these techniques may be implemented in hardware, firmware, software, or a combination thereof. Hardware implementations may include application specific integrated circuits (ASICs), digital signal processors (DSPs), programmable logic devices (PLDs), field programmable gate arrays (FPGAs), processors, controllers, micro-controllers, microprocessors, electronic devices, other electronic units designed to perform the functions described herein, or a combination thereof. A firmware and/or software implementation may include instructions (e.g., procedures, functions, and so on) that may be utilized to perform the functions described herein. The instructions, e.g., as software or firmware, may be stored in a memory and executed by a processor. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method for processing symbols transmitted via a first plurality of antennas and received via a second plurality of antennas, the method comprising:
a. receiving symbol streams corresponding to a sub-carrier frequency from each of the second plurality of antennas;
b. generating estimated symbol streams for the sub-carrier frequency for each of the first plurality of antennas;
c. selecting an estimated symbol stream corresponding to one of the first plurality of antennas for interference cancellation;
d. transforming the selected symbol stream into time domain and decoding the selected symbol stream;
e. transforming the decoded symbol stream into frequency domain; and
f. performing interference cancellation using the decoded symbol stream.

2. The method of claim 1, wherein generating estimated symbol streams for the sub-carrier frequency for each of the first plurality of symbol streams comprises performing a minimum mean squared error (MMSE) algorithm.

3. The method of claim 1, wherein generating estimated symbol streams for the sub-carrier frequency for each of the first plurality of symbol streams comprises performing one of a zero-force or a maximum likelihood algorithm.

4. The method of claim 1, wherein the method is performed at a base station.

5. The method of claim 4, wherein the method is performed to process symbols received via an up-link from a mobile device.

6. The method of claim 1, wherein the symbol streams are modulated according to the single carrier frequency division multiple access modulation scheme.

7. The method of claim 1 further comprising repeating steps b to f until only one of the received symbol streams remains to be selected as part of step c.

8. A receiver for processing symbols transmitted via a first plurality of antennas, the receiver comprising:
a. a second plurality of antennas for receiving symbol streams corresponding to a sub-carrier frequency;
b. at least one block for generating estimated symbol streams for the sub-carrier frequency for each of the first plurality of antennas;
c. at least one block for selecting an estimated symbol stream corresponding to one of the first plurality of antennas for interference cancellation;
d. at least one block for transforming the selected symbol stream into time domain and decoding the selected symbol stream;
e. at least one block for transforming the decoded symbol stream into frequency domain; and
f. at least one block for performing interference cancellation using the decoded symbol stream.

9. The receiver of claim 8, wherein generating estimated symbol streams for the sub-carrier frequency for each of the first plurality of symbol streams comprises performing a minimum mean squared error (MMSE) algorithm.

10. The receiver of claim 8, wherein generating estimated symbol streams for the sub-carrier frequency for each of the first plurality of symbol streams comprises performing one of a zero-force or a maximum likelihood algorithm.

11. The receiver of claim 18 wherein the receiver is part of a base station.

12. The receiver of claim 11, wherein the receiver is used to process symbols received via an up-link from a mobile device.

13. The receiver of claim 8, wherein the symbol streams are modulated according to the single carrier frequency division multiple access modulation scheme.

14. A system for processing symbols transmitted via a first plurality of antennas and received via a second plurality of antennas, the system comprising:
a. means for receiving symbol streams corresponding to a sub-carrier frequency from each of the second plurality of antennas;
b. means for generating estimated symbol streams for the sub-carrier frequency for each of the first plurality of antennas;
c. means for selecting an estimated symbol stream corresponding to one of the first plurality of antennas for interference cancellation;
d. means for transforming the selected symbol stream into time domain and decoding the selected symbol stream;
e. means for transforming the decoded symbol stream into frequency domain; and
f. means for performing interference cancellation using the decoded symbol stream.

15. The system of claim 14, wherein the means for generating estimated symbol streams for the sub-carrier frequency for each of the first plurality of symbol streams comprises means for performing a minimum mean squared error (MMSE) algorithm.

16. The system of claim 14, wherein the means for generating estimated symbol streams for the sub-carrier frequency for each of the first plurality of symbol streams comprises means for performing one of a zero-force or a maximum likelihood algorithm.

17. The system of claim 14, wherein the system comprises a base station.

18. The system of claim 17, wherein the system processes symbols received via an up-link from a mobile device.

19. The system of claim 14, wherein the symbol streams are modulated according to the single carrier frequency division multiple access modulation scheme.

20. The system of claim 14 further comprising means for repeating steps b to f until only one of the received symbol streams remains to be selected as part of step c.
